(19) United States
(12) Patent Application Publication
(10) Pub. No.: US 2009/0299689 A1
(43) Pub. Date: Dec. 3, 2009

(54) Portable Leveling Table

(76) Inventor: David Robert Stubben, Cameron Park, CA (US)

Correspondence Address: David Stubben, 3242 Western Dr, Cameron Park, CA, 95682, US

(21) Appl. No.: 12/131,864

(22) Filed: Jun. 2, 2008

(51) Int. Cl. G01C 9/00

(52) U.S. Cl. 702/154

(57) ABSTRACT

An automatic table leveling system includes a linear accelerometer, a microcontroller, motor drivers, motors and lead screws. The microcontroller reads linear accelerometer sensor information which indicates the table top's attitude with respect to the gravity vector. Then the microcontroller sends signals to the motor drivers to cause the motors to drive the table legs up or down via a lead screw mechanism. The changed leg lengths adjust the attitude of the table top to make it level.

### BACKGROUND OF THE INVENTION

1. Field of the Invention

The present invention relates to a system for automatically leveling a portable table when the portable table is set up, moved or located on terrain that may be uneven.

2. Description of Related Art

Many types of portable tables exist for use indoors and out. A good example of a special purpose manually leveled portable table is a camera tripod. In this case, the three legs can be adjusted manually in length in order to level the top portion that mounts a camera. U.S. Pat. No. 4,265,027 describes an automatic self-leveling instrument mount. This device relies on a pendulum switch to control motors that drive support arms extending between the table and a frame.

### SUMMARY OF THE INVENTION

The present invention utilizes a Micro-Electro-Mechanical System (MEMS) linear accelerometer, a microprocessor, motor drivers and motors to automatically control the leg lengths of a table for the purpose of making the table top level. These components provide a relatively low cost solution to the need for camping tables that are level which is quite desirable for certain types of outdoor cooking and other purposes. The same technology can be applied to camera tripods. The linear accelerometer senses the gravity vector to determine a level attitude. The microprocessor reads the accelerometer and interprets any deviation from a level attitude to drive the motors that lengthen or shorten the table's leg lengths to cause the table top to be level. A first embodiment, the simplest and lowest cost implementation, would have one fixed length leg and two motor driven legs. A second embodiment would have three motor driven legs—allowing the additional benefit of having an adjustable table height. A third embodiment would have one fixed length leg and three motor driven legs—allowing for better stability than the three leg solution by placing the legs at the corners of a square or rectangular table top. Finally, a fourth and preferred embodiment would have four motor driven legs—allowing for better stability and an adjustable table top height. In order to enhance portability, the legs will be manually foldable under the table surface when not in use. An electronic circuit board that contains the linear accelerometer, microprocessor and motor drivers mounts just below the table top and is referenced to the table top such that the linear accelerometer senses the attitude of the table top.

### BRIEF DESCRIPTION OF THE DRAWINGS

The present invention may be better understood, and its many features and advantages made apparent to those skilled in the art by referencing the attached drawings.

FIG. 1 is an illustration of the automatic portable self-leveling table in accordance with the preferred embodiment of the present invention.

FIG. 2 is a block diagram of an electronic system in accordance with the preferred embodiment of the present invention.

FIG. 3 is a flow chart that illustrates the process performed by the microprocessor in accordance with the preferred embodiment of the present invention.

FIG. 4 is an illustration of the table leg including motor and lead screw drive.

### DESCRIPTION OF THE PREFERRED EMBODIMENT

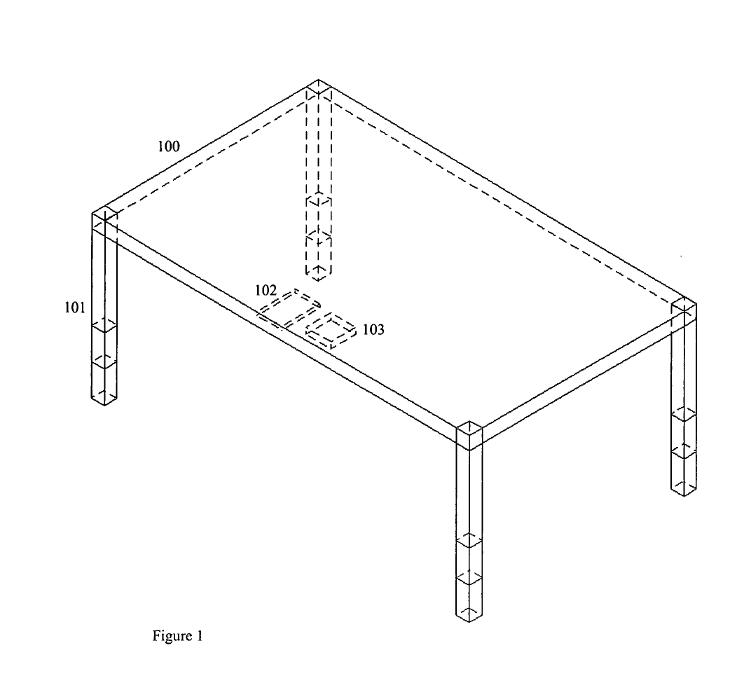

FIG. 1 is an illustration of the automatic portable self-leveling table. A table top 100 is supported by four legs 101. An electronic circuit board 102 is powered by battery pack 103. It should be understood that other means of powering the circuit board are possible. For example, an AC adapter or solar cells could be used. The circuit board 102 is connected to motors contained inside the legs 101 of the table. It is not essential to contain the motors within the legs except for esthetic reasons. As noted above, this is the preferred embodiment. Other embodiments are also noted above.

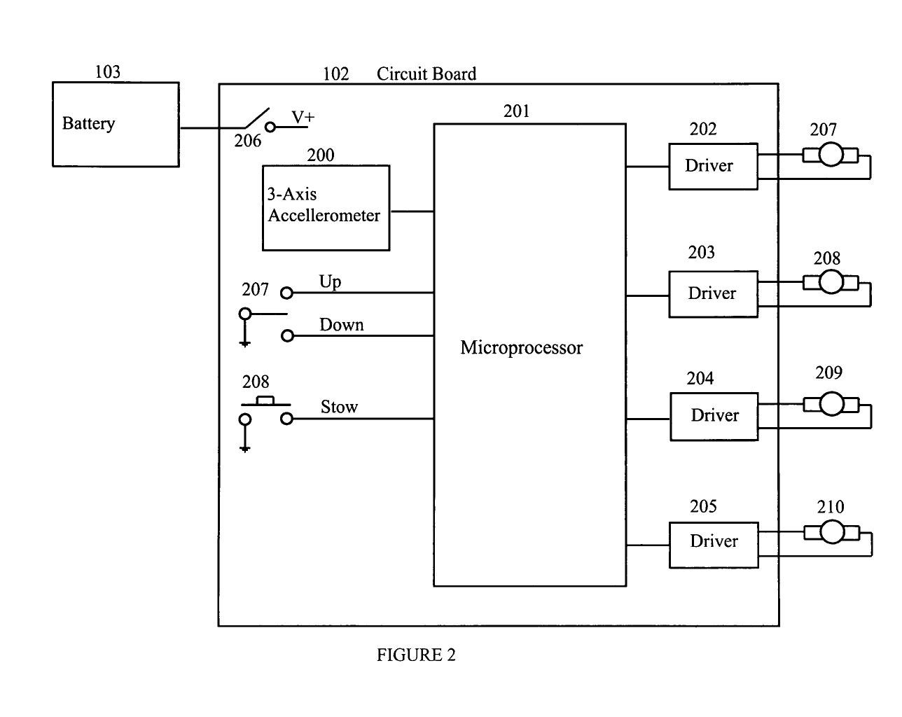

FIG. 2 is a block diagram of an electronic system in accordance with the preferred embodiment of the present invention. The circuit board's main components are the 3-axis MEMS accelerometer 200 (e.g. a LIS302DL—manufactured by STMicroelectronics), microprocessor 201 (e.g. a MSP430F2232—Manufactured by Texas Instruments) and motor drivers 202-205 (e.g. A3950SLP's—Manufactured by Allegro Microsystems). The battery 103 is shown off board, but could be mounted on board. Motors 207-210 connect to the motor drivers. The circuit board is mounted such that the board is in parallel with the table top in both surface axes of the table top. This is for the purpose of simplicity. In fact the relationship between the board and the table top may have any attitude since a difference vector in three dimensions can be known and the three dimensional accelerometer can provide information to accommodate the calculations necessary to perform the table top leveling.

In addition to the components already defined, there are: switch 206 for turning the power on or off, switch 207 for raising or lowering the table top height and switch 208 for stowing the table legs (causing all legs to retract to minimal length).

In addition to the functionality already described, each motor driver includes a current sense resistor. The voltage across this resistor is read by an analog to digital converter that is part of the microprocessor 201. In this manner, the process knows the current in the motors. The purpose of this is to eliminate the need for limit switches (thus reducing cost) which would otherwise be required to indicate that the limit of the range of the leg extension or retraction had been reached.

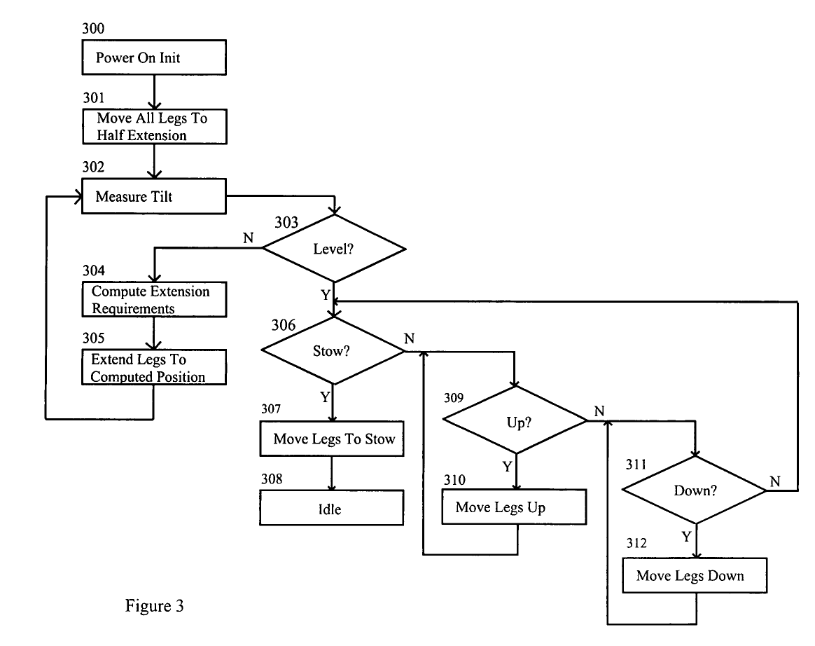

FIG. 3 is a flow chart that illustrates the process performed by the system controller. A power on initialization 300 is first performed in which system parameters are set up and the leg positions are driven to the stowed position. In the next process element 301, all legs are moved to half extension by driving them for a given amount of time having previously determined the drive time empirically. Process element 302 measures the tilt of the table by reading the accelerometer. This reading is the vector of gravity with respect to the circuit board. If the circuit board and table top are not in parallel, the known difference is compensated here. Process element 303 determines if the table top is level by comparing the gravity vector to the vector of the table top. When these vectors do not agree, the process 304 of computing the extension (or retraction) requirements are performed and process 305 extends (retracts) the legs to the computed position. Next, the process goes back to element 302 to again measure the tilt of the table top. If in process 303, the table is now level, tests are performed on the stow, up and down switches to perform the desired functions as necessary. In the case of the stow switch being found active 306, all legs are retracted 307 and the processor goes into an idle state 308. In the case of the up switch being active 309, the legs are all moved up 310 for as long as the switch stays active. In the case of the down switch being active 311, the legs are all moved down 312 for as long as the switch stays active. In addition to the process shown, all motors are continuously monitored for the current they are using to determine if they have reached the limit of their range. If they do reach a limit, a flag is set to inhibit driving the motor in that direction until it has been driven in the opposite direction.

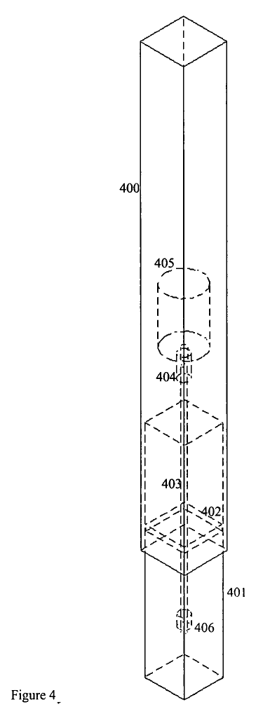

FIG. 4 is an illustration of the table leg including motor and lead screw drive. The top portion 400 of table leg 101 is nominally constructed of square aluminum tubing large enough to house the motor 405 which is fastened to this tubing 400. The bottom portion 401 of table leg 101 is also nominally constructed of square aluminum tubing that is smaller in size than the top portion such that it can be held stable by the top portion but also slide within the top portion. Other materials besides aluminum may be used. Other shapes of tubing besides square may be used provided that the bottom portion is restricted from rotating within the top portion. A coupler 404 attaches a threaded rod 403 to the shaft of motor 405. A plate 402 is fixed by welding or other fastening means to bottom portion 401 and includes a mating threaded section to accommodate the threaded rod 403. An end cap 406 is attached to the end of the threaded rod 403 to provide a stop so that the threaded rod may not escape the bottom portion. Therefore it can be seen that the rotation of the motor causes the threaded rod to rotate and in turn causing the bottom portion of the table leg to extend or retract depending on the direction of the motor's rotation. Upon extension, if the plate 402 hits the end cap 406, the motor current will rise to an amount that is detected as the limit. Upon retraction, if the plate 402 hits the coupler 404, the motor current will rise to an amount that is detected as the limit.

I claim:

1. An automatic table leveling system including: a linear accelerometer that senses the attitude of the table with respect to the gravity vector, a controller coupled to the linear accelerometer for reading the attitude information and processing said information to create motor control signals for leveling the table top, motor drivers coupled to the controller to receive said signals and a motor coupled to each motor driver that can extend or retract an associated table leg.

2. The automatic table leveling system of claim 1 wherein the linear accelerometer is a MEMS accelerometer.

3. The automatic table leveling system of claim 1 wherein the controller is a microprocessor.

4. The automatic table leveling system of claim 1 wherein the motor is a DC motor.

5. The automatic table leveling system of claim 1 wherein the motor is a stepping motor.

6. The automatic table leveling system of claim 1 wherein the rotary motion of each motor is changed to linear motion with a lead screw causing the associated table leg's length to be extended or retracted.

7. The automatic table leveling system of claim 1 including a switch to control the height of the table top.

8. The automatic table leveling system of claim 1 including the ability to sense the current in each motor in order to determine the limit of travel for the associated table leg.

9. An automatic table leveling system including: attitude sensing means for sensing the attitude of the table top with respect to the gravity vector; control means coupled to said attitude sensing means for reading the attitude information, processing said information and outputting control signals; leg length actuator means, responsive to said control signals for extending or retracting the legs of a table so as to level the table.

10. The automatic table leveling system of claim 9 wherein the attitude sensing means is a MEMS accelerometer.

11. The automatic table leveling system of claim 9 wherein the control means is a microprocessor.

12. The automatic table leveling system of claim 9 wherein the leg length actuator means includes a motor driver, DC motor and lead screw linkage.

13. The automatic table leveling system of claim 9 wherein the leg length actuator means includes a motor driver, stepping motor and lead screw linkage.

14. The automatic table leveling system of claim 9 including a means to set the table top height.

15. The automatic table leveling system of claim 9 including a means to detect the limit the travel of the table legs.
